(19) United States
(12) Patent Application Publication
(10) Pub. No.: US 2026/0237945 A1
(43) Pub. Date: Aug. 13, 2026

(54) SHIELDED PLUG CONNECTOR WITH EARTHING CONTACT AND METHOD FOR ASSEMBLY OF SAME

(71) Applicant: HARTING Electric Stiftung & Co. KG, Espelkamp (DE)

(72) Inventor: Sebastian GRIEPENSTROH, Luebbecke (DE)

(21) Appl. No.: 19/159,264

(22) PCT Filed: Mar. 15, 2024
(86) PCT No.: PCT/DE2024/100211

§ 371 Date: Aug. 22, 2025

(30) Foreign Application Priority Data
Mar. 31, 2023 (DE) 102023108288.4

(51) Int. Cl. H01R 13/6597

(52) U.S. Cl. CPC H01R 13/6597

(57) ABSTRACT

Disclosed is housing and method which reduces the push-in force of an earthing contact into a contact carrier of a shielded plug connector during assembly of said plug connector, and nevertheless produce a user-friendly earthing connection between the earthing contact and a metal plug connector housing, the invention proposes an electrically conductive connection element which automatically functions according to the principle of a rocker when the contact carrier is inserted into the plug connector housing.

### BACKGROUND OF THE INVENTION

The invention relates to a plug connector and a method for assembling a shielded plug connector.

Such plug connectors are required both to transfer an earth connection, in particular a so-called “PE” (“Protective Earth”) connection, to a mating plug connector, and to earth their own plug connector housings for safety reasons and for shielding purposes.

Document WO 2007/019918 A1 discloses a plug having a housing formed as a sleeve and having an insulating body which is arranged in said housing and has elongate contacts. The plug has an electrically conductive holding spring for an earthing contact, said holding spring having, for the earthing contact, an insertion part which is continuous in an axial direction and which is in particular sleeve-shaped and which, in a usage position, is arranged within a hole or bore in the insulating body. The insertion part of the holding spring fits through a lateral opening in the insulating body. The bore forms, together with said lateral opening, an undercut for the somewhat elastically compressible insert part. Extending on the outer side of the insertion part is a spring arm which is arranged on the outer side of the insulating body even in the usage position and which makes contact with the inner side of the sleeve and which, on its free end, has an inwardly directed projection which engages into a depression or recess in the earthing contact and fixes the earthing contact in an axial direction.

A disadvantage of this design is that, during the assembly of the plug connector, an undesirably high insertion force must be applied in order to achieve a pressing force between the earthing contact and the holding spring which is high enough for a secure earthing connection.

In the priority application relating to the present application, the German Patent and Trade Mark Office conducted a search in respect of the following documents: DE 103 23 614 A1, DE 10 2016 213 952 A1, JP H08-6389 Y2 and JP H08-6390 Y2.

### SUMMARY OF THE INVENTION

It is the object of the invention to simplify the assembly of a shielded plug connector having an earthing contact. In particular, it is sought to reduce the force with which the earthing contact is inserted into a contact carrier of the plug connector and to nevertheless make it possible to achieve a user-friendly earthing connection between the earthing contact and a metallic plug connector housing, without a further manual working step and without the need for further additional parts.

The problem is solved by the subject matter of independent claim 1.

A plug connector has the following:
a metallic plug connector housing;
a contact carrier which, for the assembly of the plug connector, can be inserted in a plug-in direction into the plug connector housing and which consists of an electrically insulating material, wherein the contact carrier has the following:
   a cable connection side;
   a plug-in side situated parallel to and opposite the cable connection side;
   a side wall which extends in the plug-in direction and which connects the cable connection side to the plug-in side;
   a plurality of through openings, which extend in the plug-in direction and connect the cable connection side to the plug-in side, as contact chambers for receiving plug-in contacts;
      wherein one of the contact chambers is an earthing contact chamber which is distinguished by the fact that it has a lateral connecting opening to the aforementioned side wall of the contact carrier;
for each of the contact chambers, a metallic plug-in contact arranged in the associated contact chamber;
   wherein each of said plug-in contacts has a plug-in region at a plug-in end and has a cable connection region at a cable connection end situated opposite the plug-in end, and
   wherein that one of the plug-in contacts which is arranged in the earthing contact chamber is an earthing contact,
a connecting element for electrically conductively connecting the earthing contact to the plug connector housing,
   wherein a part of the connecting element is arranged in the connecting opening of the earthing contact chamber,
   and wherein the connecting element has a lever arm at a first end and has a contact portion at a second end situated opposite the first end,
      wherein the connecting element, the plug-in contact, the contact carrier and the plug connector housing are together configured to, during the assembly of the plug connector, mechanically and thus also electrically connect the connecting element, at its lever arm, to the plug connector housing as a result of the insertion of the contact carrier into the plug connector housing, and to pivot the lever arm inward in the process, whereby, in accordance with the functional principle of a rocker, the contact portion moves outward and thereby, in the assembled state of the plug connector, mechanically and thus also electrically connects the connecting element, at its contact portion, to the plug-in contact.

A method for assembling such a plug connector comprises the following steps:
at least partially inserting the connecting element into the earthing contact chamber, wherein a part of the lever arm and a part of the contact portion are arranged in the connecting opening, and an end part of the lever arm projects out of the side wall of the contact carrier;
inserting the plug-in contacts into the contact chambers of the contact carrier, wherein a part of the contact portion engages behind the earthing contact;
inserting the contact carrier into the plug connector housing, whereby the lever arm of the connecting element moves inward, specifically into the contact carrier, whereby
its contact portion moves outward in accordance with the functional principle of a rocker, and thereby
mechanically and electrically connects the connecting element, at its contact portion, to the earthing contact.

In one advantageous refinement, the contact carrier may have at least one lateral holding formation which projects into the connecting opening and by means of which the connecting element is, close to the center of rotation P, captively and pivotably held at least partially in the earthing contact chamber—and thus also on the contact carrier. In the first-mentioned method step of at least partially inserting the connecting element into the earthing contact chamber, the connecting element can thus latch behind said holding formation. This also advantageously facilitates the assembly process and involves only very little additional construction effort.

Advantageous refinements of the invention are specified in the subclaims and in the following description.

The invention has the advantage that the earthing contact can be inserted into the earthing contact chamber with little force. This is possible because, during this insertion process, the earthing contact does not yet need to impart the pressing force which is required for secure electrical contacting, and which is associated with the corresponding friction force, in relation to the contact portion of the connecting element. Only during the insertion-which is necessary in any case-of the contact carrier into the plug connector housing is said pressing force automatically realized by means of a much longer insertion travel and an in particular elastic lever arm. Here, that part of the contact portion of the connecting element, in the form of the rocker, which engages behind the earthing contact is also pressed only in the radial direction against the earthing contact, without further forces, for example said friction force, arising between the earthing contact and the connecting element. The connecting element thus electrically conductively connects the earthing contact to the plug connector housing without additional effort, advantageously with minimal force having to be applied for this purpose.

Thus, for this purpose, no further components are required, nor is a further method step required.

In a preferred refinement, a part of the lever arm and a part of the contact portion of the connecting element are arranged in the connecting opening of the earthing contact chamber. A further part of the contact portion is arranged not in the connecting opening but in the earthing contact chamber, and engages behind the earthing contact. At least in that assembly state in which the connecting element has been inserted in the contact carrier but the contact carrier has not yet been inserted into the plug connector housing, an end part of the lever arm projects out of the side wall of the contact carrier, in order to be pushed inward when the contact carrier is inserted into the plug connector housing.

In a preferred refinement, the lever arm of the connecting element undergoes an elastic deformation as the contact carrier is inserted into the plug connector housing. Thus, in the assembled state, owing to said deformation, said lever arm imparts a spring force which mechanically presses the contact portion of the connecting element-with increased intensity in accordance with the lever principle-against the earthing contact and thereby, with a corresponding pressing force, mechanically and securely electrically conductively connects the connecting element to the earthing contact.

In other words, in this preferred refinement, during said assembly of the plug connector, more specifically as the contact carrier is inserted into the metallic plug connector housing, the lever arm of the connecting element undergoes an elastic deformation and thus, in the assembled state, imparts the spring force which mechanically presses the contact portion of the connecting element, with increased intensity owing to the lever principle, against the earthing contact and thereby electrically connects the connecting element to the earthing contact.

An advantage of this refinement consists in the fact that the elasticity of the entire lever arm contributes to the aforementioned pressing force. The length of the lever arm means that, from a materials aspect, the deformation remains well within in the elastic range, that is to say only a very slight elastic deformation is required, and therefore plastic deformations of the connecting element in the assembled state, even over a long period of time, are practically ruled out. The desired pressing force can also be set very exactly by means of the length of the lever arm.

In a further advantageous refinement, the connecting element consists of resiliently elastic sheet metal and is formed as a single piece. The connecting element is thus a sheet-metal part, in particular a so-called PE (“Protective Earth”) metal sheet.

In a further advantageous refinement, the connecting element is formed inexpensively as a punched and bent part.

In a further advantageous refinement, the lever arm of the connecting element has an elongate connecting piece, and the contact portion is substantially ring-shaped, that is to say designed in the form of an open or closed ring, for example in a form of an eyelet and/or of a hollow cylinder of slotted or non-slotted form, in order to at least partially encompass the earthing contact or at least engage behind the earthing contact. This is because the encompassing contact portion has an inner diameter that at least slightly exceeds the diameter of the plug-in region. The contact portion furthermore has an outer diameter that is at least slightly smaller than the diameter of the earthing contact receptacle. This has the effect that the contact portion in the earthing contact receptacle has the necessary play in order that it can advantageously be elastically pressed, as a second lever arm, specifically as a load arm, against the earthing contact.

In a preferred refinement, the lever arm has, at its end region, adjoining the connecting piece, a widened portion as a contacting region for particularly good electrical contacting of the plug connector housing. The enlarged contact area advantageously also improves the electrical conductance of this electrical connection.

In a further advantageous refinement, the lever arm has an—in particular slight—S shape, that is to say is of S-shaped design. This means in particular that the connecting piece, proceeding from its end region, is firstly curved inwardly and is then curved outwardly again proceeding from an inflection point. Each of these two curvatures may amount to more than 5° and less than 40°, in particular more than 10° and less than 35°, preferably more than 14° and less than 30°, particularly preferably more than 18° and less than 26°, that is to say for example between 20° and 24, that is to say for example between 22° and 21.5°.

In a preferred refinement, the connecting element and the plug-in contact, in the assembled state, have a common bearing point at which the connecting element is supported during its lever movement. This is advantageous because a further electrically conductive connection thus exists between these elements. Furthermore, owing to the metallic material of said parts, the friction is extremely low.

In a preferred refinement, the connecting element has, at said bearing point, a bearing portion which is arranged between the lever arm and the contact portion. This is particularly advantageous because the contact portion thus acts as a load arm.

In a further advantageous refinement, the contact carrier is cylindrical, and the plug connector housing has a hollow cylindrical basic shape. The plug connector is thus advantageously designed as a circular plug connector.

### BRIEF DESCRIPTION OF THE DRAWINGS

An exemplary embodiment of the invention is illustrated in the drawings and will be discussed in more detail below. In the drawings:

FIG. 1a, b show a connecting element in two different views;

FIG. 1c shows an earthing contact having the connecting element;

FIG. 1d shows a contact carrier fitted with the earthing contact, the connecting element and further plug-in contacts;

FIG. 2a shows the contact carrier having the plug connector housing;

FIG. 2b, c show the contact carrier having the earthing contact and having the connecting element, in the absence of and in the presence of an actuating force;

FIG. 2d shows the connecting element with the curvature angle a of its lever arm.

### DETAILED DESCRIPTION OF THE INVENTION

The figures contain, in part, simplified schematic illustrations. In some cases, the same reference designations will be used for similar but not necessarily identical elements. Different views of the same elements may be scaled differently. Directional terminology such as “left”, “right”, “top” and “bottom” is to be understood in relation to the particular figure, and may vary in relation to the illustrated object in the individual illustrations.

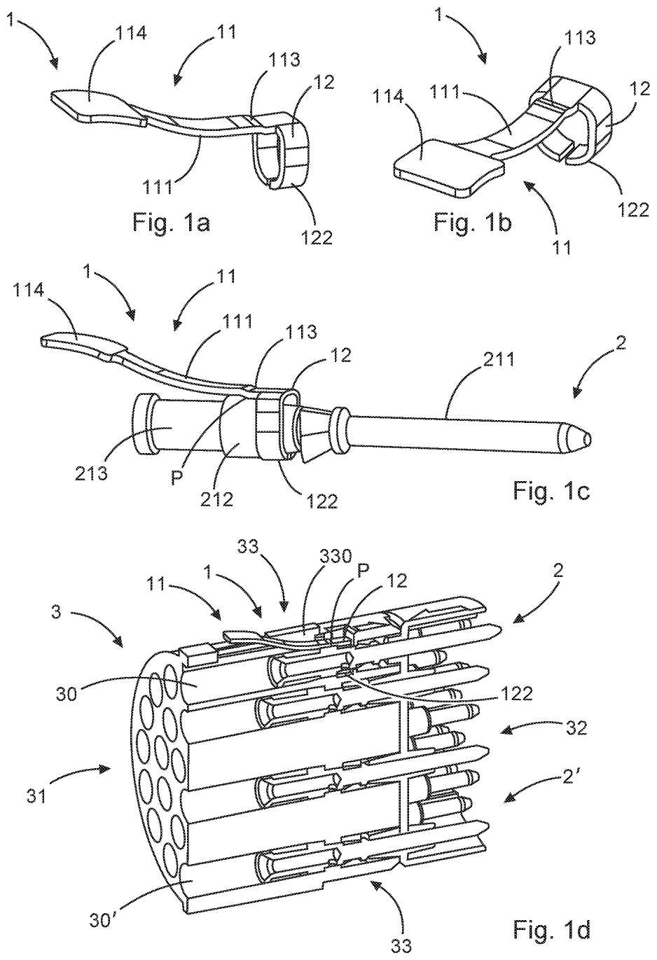

FIGS. 1a and 1b show a connecting element 1 formed as a punched and bent part from resiliently elastic sheet metal. In an alternative embodiment that is hereby expressly disclosed as belonging to the invention, the connecting element 1 could however also be formed from some other material, for example from an electrically conductive plastics material and/or from a plastics material coated with an electrically conductive material.

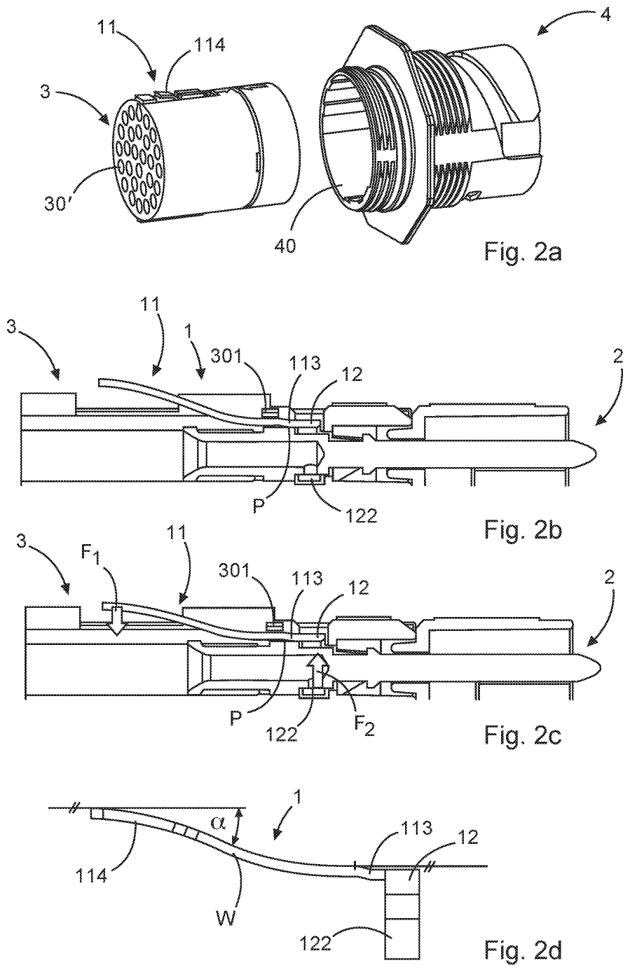

The connecting element 1 has a lever arm 11 bent into a slight S shape. This S shape will be discussed in more detail once again further below with reference to FIG. 2d. The lever arm 11 has, in its end region, a widened portion as a contacting region 114. Adjoining this, the lever arm has an elongate connecting piece 111. The connecting element 1 also has a bearing portion 113, via which the connecting piece 111 is connected to a contact portion 12 of the connecting element 1.

The contact portion 12 is substantially ring-shaped in order, as shown in FIG. 1c, to at least partially encompass an earthing contact 2 at its collar 212 and thus, by way of a rear-engagement means 122 belonging to the contact portion 12, to engage behind the earthing contact 2 from below in the drawing. In this embodiment, the contact portion 12 is opened, at its rear-engagement means 122, by means of a slot that is not designated in any more detail. This is owing to the fact that, as already mentioned, said contact portion is formed as a punched and bent part and can be produced more easily in this way. Furthermore, depending on the form of the earthing contact 2, the slot may facilitate the insertion of the earthing contact 2. Variants of the connecting element 1 in which the contact portion 12 has no slot, that is to say is of closed design, are thus also possible, and are hereby also disclosed as belonging to the invention.

The single-piece earthing contact 2 has a plug-in region 211, which is illustrated on the right in the drawing, and a cable connection region 213, which is illustrated on the left in the drawing and is designed as a crimp connection and serves for the connection of an earthing cable (not shown).

A bearing point P is formed between the earthing contact 2 and the bearing portion 113 of the connecting element 1, about which bearing point the lever arm 11 of the connecting element 1, during its downward actuation in the drawing, is pivoted relative to the earthing contact 2. It is easily conceivable that a downward actuation of the lever arm 11 causes that part of the contact portion 12 which is illustrated at the bottom and which engages behind the earthing contact 2 to be pulled against the earthing contact 2 in an upward direction from below.

This situation is made even clearer in FIG. 1d. Said figure shows—together with the aforementioned components—a contact carrier 3. The contact carrier 3 has a cable connection side 31 and a plug-in side 32 situated parallel to and opposite the cable connection side. The contact carrier 3 also has a side wall 33 which extends in a plug-in direction and which connects the cable connection side 31 to the plug-in side 32. Since the contact carrier 3 is substantially cylindrical, it has only one—encircling—side wall 33. A further, for example cuboidal design would self-evidently also be conceivable, and is hereby also expressly disclosed as belonging to the invention. The corresponding contact carrier would then additionally have, for example, a further three further side walls, that is to say a total of four side walls.

The contact carrier 3 has a plurality of through openings, which extend in the plug-in direction and which connect the cable connection side 31 to the plug-in side 32, as contact chambers 30, 30′ for receiving plug-in contacts 2, 2′, namely an earthing contact chamber 30 for receiving the earthing contact 2 and further contact chambers 30′ for receiving further plug-in contacts 2′, wherein said further plug-in contacts 2′ do not need to differ from the earthing plug-in contact 2, that is to say may be of identical design thereto. The distinction between the earthing plug-in contact 2 and the further plug-in contacts 2′ is therefore to be understood as being primarily functional.

However, the earthing contact chamber 30 also physically differs somewhat from the further contact chambers 30′, because the earthing contact chamber 30 has a lateral connecting opening 330 to the aforementioned side wall 33 of the contact carrier 3. The connecting element 1 is arranged partially, namely with a part of its connecting piece 111, its bearing portion 113, and the upper part of its contact portion 12 in the drawing, in said connecting opening 330. Within the earthing contact chamber 30, the contact portion 12 encompasses the earthing contact 2 arranged in the earthing chamber 30, and in so doing engages by way of the rear-engagement means 122, illustrated at the bottom, of its contact portion 12 behind the earthing contact 2.

FIG. 2a shows how the cylindrical contact carrier 3 is inserted, from the left in the drawing, that is to say on the cable connection side, into a housing opening 40 of a substantially hollow cylindrical plug connector housing 4. It is clearly apparent from this, following the preceding illustrations, that the contacting region 114 of the connecting element 1 firstly makes electrical contact with the plug connector housing 4. Secondly, the lever arm 11 is thus also moved downward in the drawing, that is to say radially inward.

FIGS. 2b and 2c show the process in which the actuating force F1, which is generated as a result of the aforementioned insertion of the contact carrier 3 into the plug connector housing 4 and which is directed downward in the drawing and thus radially inward, acts on the lever arm 11. The connecting element 1, in the form of a rocker, then rotates about the bearing point P. The contact portion 12 is thus raised and presses by way of its rear-engagement means 122 from below in the drawing, that is to say radially outward, against the earthing contact 2 with the pressing force F2, which is increased owing to the lever.

Furthermore, when the contact carrier 3 is inserted into the plug connector housing 4, the lever arm 11 of the connecting element 1 undergoes an elastic deformation and thus, owing to said deformation, imparts the spring force which mechanically presses the contact portion 1 of the connecting element 1, with increased intensity in accordance with the lever principle and with the accordingly increased, upwardly—that is to say radially outwardly—directed pressing force F2 as a contact force, against the earthing contact 2 and thus mechanically and securely electrically connects the connecting element 1 to the earthing contact 2. Here, in the assembled state shown, the connecting element 1 is held captively, and furthermore also pivotably, at least partially in the earthing contact chamber 30—and on the contact carrier 3—by means of a holding formation 301, which projects laterally into the connecting opening 330, close to the center of rotation P.

Thus, during its prior assembly, the earthing contact 2 can be inserted into the earthing contact chamber 30 of the contact carrier 3 with very little expenditure of force, specifically with similar expenditure of force to that which is commonly also necessary for the further plug-in contacts 2′ and further contact chambers 30′. Only as a result of the contact carrier 3 being installed into the plug connector housing 4 is secure electrical contact, which can be maintained without problems over a long period of time, established between the earthing contact 2 and the plug connector 4 by means of the connecting element 1.

FIG. 2d shows once again in detail the S shape of the lever arm 11 of the connecting element 1. Proceeding from the inflection point W, the lever arm 11 is curved slightly downwardly in the drawing, that is to say inwardly, toward the first end, illustrated on the left in the drawing, of the connecting element 1, and is curved slightly upwardly again, that is to say outwardly, toward the contact portion 12 illustrated on the right. Both curvatures have the angle α, wherein the angle α in this embodiment is between 20° and 22° in the non-actuated state.

Even though various aspects or features of the invention have been presented in each case in combination in the figures, it is apparent to a person skilled in the art that—unless stated otherwise—the combinations that have been illustrated and discussed are not the only possibilities. In particular, mutually corresponding units or feature combinations from different exemplary embodiments may be interchanged with one another.

### LIST OF REFERENCE SIGNS

1 Connecting element
11 Lever arm
111 Connecting piece
113 Bearing portion
114 Contacting region
12 Contact portion
122 Rear-engagement means
2, 2′ Earthing contact, plug-in contacts
211 Plug-in region
212 Collar
213 Cable connection region, crimp connection
3 Contact carrier
30, 30′ Earthing contact chamber, contact chambers
301 Holding formation
31 Cable connection side
32 Plug-in side
33 Side wall
330 Connecting opening
4 Plug connector housing
40 Housing opening
P Bearing point
W Inflection point
F₁ Actuating force, spring force
F₂ Pressing force, contact force

1. A plug connector, comprising
a metallic plug connector housing;
a contact carrier which, for the assembly of the plug connector, can be inserted in a plug-in direction into the plug connector housing and which is formed of an electrically insulating material, wherein the contact carrier has the following:
a cable connection side;
a plug-in side situated parallel to and opposite the cable connection side;
a side wall which extends in the plug-in direction and which connects the cable connection side to the plug-in side;
a plurality of through openings, which extend in the plug-in direction and connect the cable connection side to the plug-in side, as contact chambers for receiving plug-in contacts;
wherein one of the contact chambers is an earthing contact chamber which is distinguished by the fact that it has a lateral connecting opening to the aforementioned side wall of the contact carrier;
wherein the plug connector also has the following:
for each of the contact chambers, a metallic plug-in contact arranged in the associated contact chamber;
wherein each of said plug-in contacts has a plug-in region at a plug-in end and has a cable connection region at a cable connection end situated opposite the plug-in end, and
wherein that one of the plug-in contacts which is arranged in the earthing contact chamber is an earthing contact,
a connecting element for electrically conductively connecting the earthing contact to the plug connector housing,
wherein a part of the connecting element is arranged in the connecting opening of the earthing contact chamber,
and wherein the connecting element has a lever arm at a first end and has a contact portion at a second end situated opposite the first end,
wherein the connecting element, the earthing contact, the contact carrier and the plug connector housing are together configured to, during the assembly of the plug connector, mechanically and thus also electrically connect the connecting element, at its lever arm, to the plug connector housing as a result of the insertion of the contact carrier into the plug connector housing, and to pivot the lever arm inward in the process, whereby, in accordance with the functional principle of a rocker, the contact portion moves outward and thereby mechanically and thus also electrically connects the connecting element, at its contact portion, to the earthing contact.

2. The plug connector as claimed in claim 1, wherein a part of the lever arm and a part of the contact portion of the connecting element are arranged in the connecting opening of the earthing contact chamber, wherein a further part of the contact portion is arranged not in the connecting opening but in the earthing contact chamber and, there, engages behind the earthing contact, and wherein—at least in that assembly state in which the connecting element has been inserted in the contact carrier but the contact carrier has not yet been inserted into the plug connector housing—an end part of the lever arm projects out of the side wall of the contact carrier.

3. The plug connector as claimed in claim 1, wherein the lever arm of the connecting element undergoes an elastic deformation as the contact carrier is inserted into the plug connector housing, and in the assembled state, owing to said deformation, said lever arm imparts a spring force which presses the contact portion of the connecting element with a pressing force, which is of increased intensity in accordance with the lever principle, against the earthing contact and thereby mechanically and electrically conductively connects the connecting element to the earthing contact.

4. The plug connector as claimed in claim 1, wherein the connecting element is formed from a resiliently elastic sheet metal and is formed as a single piece.

5. The plug connector as claimed in claim 1, wherein the connecting element is formed as a punched and bent part.

6. The plug connector as claimed in claim 1, wherein the lever arm of the connecting element has an elongate connecting piece, and the contact portion is substantially ring-shaped in order to at least partially encompass, or at least engage behind, the earthing contact.

7. The plug connector as claimed in claim 1, wherein the lever arm has, at its end region, a widened portion as a contacting region for particularly good electrical contacting of the plug connector housing.

8. The plug connector as claimed in claim 1, wherein the lever arm is S-shaped.

9. The plug connector as claimed in claim 8, wherein the lever arm, in its assembled state, is slightly inwardly curved toward the first end of the connecting element and is slightly outwardly curved toward the contact portion.

10. The plug connector as claimed in claim 1, wherein the connecting element and the earthing contact, in the assembled state, have a common bearing point at which the connecting element is supported during its lever movement.

11. The plug connector as claimed in claim 10, wherein the connecting element has, at the bearing point, a bearing portion which is arranged between the lever arm and the contact portion.

12. The plug connector as claimed in claim 1, wherein the contact carrier is cylindrical, and the plug connector housing has a hollow cylindrical basic shape.

13. A method for assembling a plug connector as claimed in claim 1, wherein the method comprises the following steps:
at least partially inserting the connecting element into the earthing contact chamber, wherein a part of the lever arm and a part of the contact portion are arranged in the connecting opening, and an end part of the lever arm projects out of the side wall of the contact carrier;
inserting the plug-in contacts into the contact chambers of the contact carrier, wherein a part of the contact portion engages behind the earthing contact;
inserting the contact carrier into the plug connector housing, whereby
the lever arm of the connecting element moves inward, specifically into the contact carrier, and thereby moves its contact portion outward in accordance with the functional principle of a rocker, and thereby
mechanically and electrically connects the connecting element, at its contact portion, to the earthing contact.

14. The method as claimed in claim 13, wherein the lever arm of the connecting element undergoes an elastic deformation during said assembly process, and in the assembled state, owing to said deformation, imparts the spring force which mechanically presses the contact portion of the connecting element, with increased intensity owing to the lever principle, against the earthing contact and thereby electrically connects the connecting element to the earthing contact.

15. The plug connector as claimed in claim 2, wherein the lever arm of the connecting element undergoes an elastic deformation as the contact carrier is inserted into the plug connector housing, and in the assembled state, owing to said deformation, said lever arm imparts a spring force which presses the contact portion of the connecting element with a pressing force, which is of increased intensity in accordance with the lever principle, against the earthing contact and thereby mechanically and electrically conductively connects the connecting element to the earthing contact.

16. The plug connector as claimed in claim 2, wherein the connecting element is formed resiliently elastic sheet metal and is formed as a single piece.

17. The plug connector as claimed in claim 2, wherein the connecting element is formed as a punched and bent part.

18. The plug connector as claimed in claim 2, wherein the lever arm of the connecting element has an elongate connecting piece, and the contact portion is substantially ring-shaped in order to at least partially encompass, or at least engage behind, the earthing contact.

19. The plug connector as claimed in claim 2, wherein the lever arm has, at its end region, a widened portion as a contacting region for particularly good electrical contacting of the plug connector housing.

20. The plug connector as claimed in claim 2, wherein the lever arm is S-shaped.
